(19) United States
(12) Patent Application Publication
(10) Pub. No.: US 2011/0151778 A1
(43) Pub. Date: Jun. 23, 2011

(54) RANGING UP-SIGNAL PRE-DISTORTION SYSTEM AND METHOD

(75) Inventor: Hyoungsoo LIM, Daejeon (KR)

(73) Assignee: ELETRONICS AND TELECOMMUNICATIONS RESEARCH INSTITUTE, Daejeon (KR)

(21) Appl. No.: 12/875,868

(22) Filed: Sep. 3, 2010

(30) Foreign Application Priority Data
Dec. 18, 2009 (KR) 10-2009-0127334

(51) Int. Cl. H04B 1/04; H04B 7/14

(52) U.S. Cl. 455/24; 455/114.3

(57) ABSTRACT

Provided is a ranging up-signal pre-distortion system and method. The ranging-up signal pre-distortion system may include a channel gain estimator to estimate a channel gain based on a down-signal, and a signal distortion unit to distort a ranging up-signal based on the estimated channel gain.

### CROSS-REFERENCE TO RELATED APPLICATION

This application claims the benefit of Korean Patent Application No. 10-2009-0127334, filed on Dec. 18, 2009, in the Korean Intellectual Property Office, the disclosure of which is incorporated herein by reference.

### BACKGROUND

1. Field of the Invention

The present invention relates to a ranging up-signal pre-distortion system and method that may pre-distort an up-signal, particularly, a ranging up-signal, and may transmit the pre-distorted up-signal when a terminal or a relay station transmits the up-signal to a base station or the relay station included in a communication or interactive broadcasting system.

2. Description of the Related Art

In most communication systems or interactive broadcasting systems, a base station or a relay station may wirelessly/wiredly transmit a signal, hereinafter a down-signal, to a terminal or a relay station in a service area, or may wirelessly/wiredly receive a signal, hereinafter an up-signal, transmitted from the terminal or the relay station in the service area.

In this case, the base station or the relay station may receive up-signals transmitted from all terminals or relay stations in an allocated service area within a predetermined synchronization error range. When the terminal or the relay station does not have information associated with a time expended for transmitting an up-signal to the base station or the relay station, the terminal or the relay station may transmit, to the base station or the relay station, a synchronization request signal for synchronizing a frequency and a time where the up-signal arrives at the base station or the relay station.

The terminal or the relay station may transmit, to the base station or the relay station, a frequency allocation request signal for requesting, from the base station or the relay station, allocation of frequency resources to be used for up-signal transmission.

The synchronization request signal or the frequency allocation request signal may be referred to as a ranging up-signal. The ranging up-signal may be transmitted while information associated with the up-signal transmission channel is insufficient and thus, a performance of detecting the ranging up-signal may be more inefficient than a performance of detecting the up-signal in the base station or the relay station.

FIG. 1 illustrates a reception power with respect to the up-signal according to a conventional art.

Referring to FIG. 1 a conventional terminal may be designed to enable a down-signal receiving unit and an up-signal transmitting unit to be independently operated and thus, a channel gain 110 may not be reflected when the up-signal is transmitted since information associated with a channel may be insufficient.

The conventional terminal may allocate the same amount of transmission power to each sub-carrier constituting the up-signal, regardless of the channel gain 110, and may transmit the up-signal to the base station. Therefore, a reception power 120 with respect to the up-signal received by the base station may be nonuniform as illustrated in FIG. 1.

When a channel distortion is incurred while the information associated with the channel gain 110 is insufficient, the base station may be difficult to detect the ranging up-signal transmitted from the terminal.

### SUMMARY

An aspect of the present invention provides a ranging up-signal pre-distortion system and method that may estimate a channel gain based on a down-signal transmitted from an upper node that is a base station or a relay station, may pre-distort a ranging up-signal based on the estimated channel gain, and may transmit the pre-distorted ranging up-signal and thus, the upper node may receive the ranging up-signal having a uniform feature.

Another aspect of the present invention also provides a ranging up-signal pre-distortion system and method that may estimate a channel feature from a down-signal, and may compensate for channel distortion to be experienced when a ranging signal is transmitted and thus, a performance of detecting a ranging up-signal may be improved in a base station or a relay station.

According to an aspect of the present invention, there is provided a ranging up-signal pre-distortion system including a channel gain estimator to estimate a channel gain based on a down-signal, and a signal distortion unit to distort a ranging up-signal based on the estimated channel gain.

According to an aspect of the present invention, there is provided a ranging up-signal pre-distortion method including receiving a down-signal transmitted from an upper node that is a base station or a relay station, estimating a channel gain based on the received down-signal, distorting a ranging up-signal based on the estimated channel gain, and transmitting the distorted ranging up-signal to the upper node.

Additional aspects, features, and/or advantages of the invention will be set forth in part in the description which follows and, in part, will be apparent from the description, or may be learned by practice of the invention.

### EFFECT

According to embodiments, a time expended for successfully detecting a ranging up-signal may decrease in a base station or a relay station and thus, the overall data transmission speed of a communication or interactive broadcasting system may be improved.

According to embodiments, a performance of detecting a ranging signal of a radio up transmission link may be improved in a communication or an interactive broadcasting system.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a reception power with respect to the up-signal according to a conventional art;

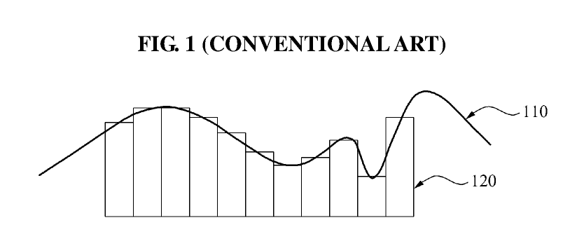

FIG. 2 is a diagram illustrating a connection among a terminal, a relay station, and a base station according to an embodiment of the present invention;

FIG. 3 is a diagram illustrating a ranging up-signal pre-distortion system according to an embodiment of the present invention;

FIG. 4 is a diagram illustrating a configuration of a ranging up-signal pre-distortion system according to an embodiment of the present invention;

FIG. 5 is a diagram illustrating an example of distorting a ranging up-signal according to an embodiment of the present invention;

FIG. 6 is a diagram illustrating a reception power with respect to a ranging up-signal according to an embodiment of the present invention; and

FIG. 7 is a flowchart illustrating a ranging up-signal pre-distortion method according to an embodiment of the present invention.

### DETAILED DESCRIPTION

Reference will now be made in detail to embodiments of the present invention, examples of which are illustrated in the accompanying drawings, wherein like reference numerals refer to the like elements throughout. Embodiments are described below to explain the present invention by referring to the figures.

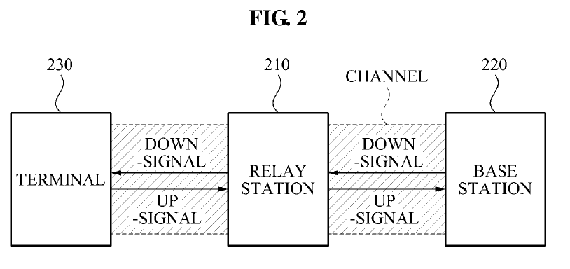

FIG. 2 illustrates a connection among a terminal, a relay station, and a base station according to an embodiment of the present invention.

Referring to FIG. 2, a communication or a broadcasting system may be an interactive system including a relay station 210, a base station 220, and a terminal 230. The base station 220 may transmit a down-signal to a terminal 230 in an allocated service area via a channel, and the terminal 230 may transmit an up-signal to the base station 220 via the channel. In this case, the base station 220 and the terminal 230 may transmit and receive the up-signal or the down-signal via the relay station 210.

A ranging up-signal pre-distortion system may be embodied inside the relay station 210 or the terminal 230 which may transmit the up-signal, specifically, a ranging up-signal.

The relay station 210 may estimate a channel gain based on the down-signal received from the base station 220, and, when an up-signal is transmitted to the base station 220, may pre-distort the up-signal based on the estimated channel gain to transmit the pre-distorted up-signal and thus, the base station 220 may receive the up-signal having a uniform feature. The relay station 210 may pre-distort the ranging up-signal based on the estimated channel gain to transmit the pre-distorted ranging up-signal to the base station 220 and thus, a performance of detecting the ranging up-signal, in the base station 220, may be improved.

The terminal 230 may estimate the channel gain based on the down-signal received from the relay station 210, and, when the ranging up-signal is transmitted to the relay station 210, may pre-distort the ranging up-signal based on the estimated channel gain to transmit the pre-distorted ranging up-signal and thus, a performance of detecting the ranging up-signal, in the relay station 210, may be improved.

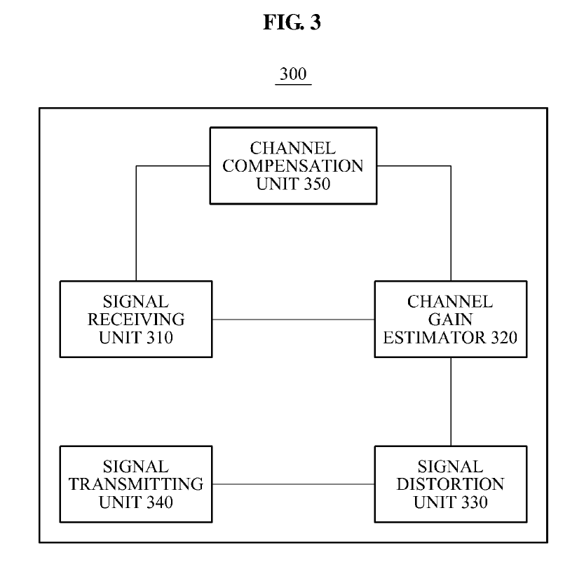

FIG. 3 illustrates a ranging up-signal pre-distortion system according to an embodiment of the present invention.

Referring to FIG. 3, the ranging up-signal pre-distortion system 300 may include a signal receiving unit 310, a channel gain estimator 320, a signal distortion unit 330, a signal transmitting unit 340, and a channel compensation unit 350.

The signal receiving unit 310 may receive, as a down-signal, a signal transmitted, via a channel, from an upper node that is a base station or a relay station, and the channel gain estimator 320 may estimate a channel gain associated with the channel based on the received down-signal.

For example, the channel gain estimator 320 may compare a transmission power and a reception power with respect to the down-signal to estimate the channel gain. For example, when a transmission power with respect to the down-signal before experiencing channel-distortion is determined as 100, and a transmission power with respect to the down-signal after experiencing the channel-distortion is determined as 90, the channel gain estimator 320 may estimate the channel gain associated with the channel as 0.9(=90/100).

The signal distortion unit 330 may distort an up-signal based on the estimated channel gain, and the signal transmitting unit 340 may transmit the distorted up-signal to the upper node.

In this case, when the ranging up-signal including a plurality of sub-carriers is generated, the signal distortion unit 330 may distort, based on the estimated channel gain, a signal power with respect to each of the plurality of sub-carriers.

The signal distortion unit 330 may distort, based on the estimated channel gain, a ranging up-signal used for synchronizing a frequency and a time where the up-signal arrives at the upper node or may distort, based on the estimated channel gain, a ranging up-signal used for requesting, from the upper node, allocation of a frequency. The signal transmitting unit 340 may transmit the distorted up-signal to the upper node. For example, the upper node may receive the ranging up-signal that may experience channel-distortion and may have a uniform feature.

For example, the distorted ranging up-signal transmitted to the upper node may experience the channel-distortion to have the uniform feature. Therefore, a time expended for successfully detecting the ranging up-signal in a base station or a relay station may decrease and thus, the overall data transmission speed may be improved and a performance of detecting the ranging up-signal may be improved.

The signal receiving 310 may receive a signal transmitted from a lower node that is a terminal or a relay station, and the channel compensation 350 may compensate for the received signal based on the estimated channel gain.

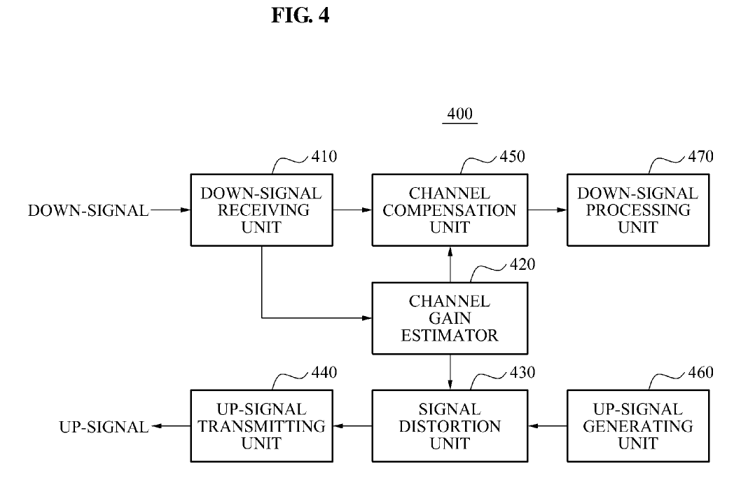

FIG. 4 illustrates a configuration of a ranging up-signal pre-distortion system according to an embodiment of the present invention.

Referring to FIG. 4, the ranging up-signal pre-distortion system 400 may include a down-signal receiving unit 410, a channel gain estimator 420, a signal distortion unit 430, an up-signal transmitting unit 440, a channel compensation unit 450, an up-signal generating unit 460, and a down-signal processing unit 470.

The down-signal receiving unit 410 may receive a down-signal from a base station or a relay station, and the channel gain estimator 420 may estimate a channel gain from the received down-signal.

When a ranging up-signal to be transmitted to the base station or the relay station is generated in the up-signal generating unit 460, the signal distortion unit 430 may pre-distort the generated ranging up-signal based on the estimated channel gain, and the up-signal transmitting unit 440 may transmit, to the base station or the relay station, the distorted ranging up-signal. The down-signal receiving unit 410 and the up-signal transmitting unit 440 may systematically operate based on the channel gain estimated by the channel gain estimator 420.

The channel compensation unit 450 may compensate for the down-signal that may experience channel-distortion and may be received from the base station or the relay station. Therefore, the down-signal processing unit 470 may process the compensated down-signal.

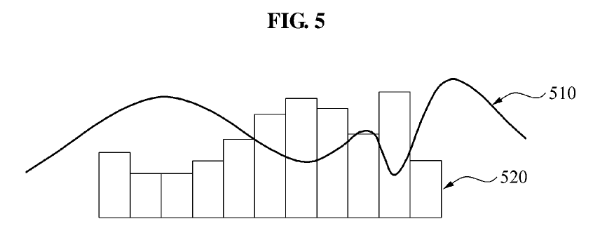

FIG. 5 illustrates an example of distorting a ranging up-signal according to an embodiment of the present invention.

FIG. 5 illustrates a channel gain 510 and a transmission power 520 with respect to the ranging up-signal. A ranging up-signal pre-distortion system may estimate the channel gain 510 based on a down-signal transmitted from a base station or a relay station via a channel, and the ranging up-signal pre-distortion system may distort a signal power of a plurality of sub-carriers constituting the ranging up-signal to be nonuniform as the transmission power 520 of FIG. 5. The ranging up-signal pre-distortion system may transmit, to the base station or the relay station, the ranging up-signal having the transmission power 520.

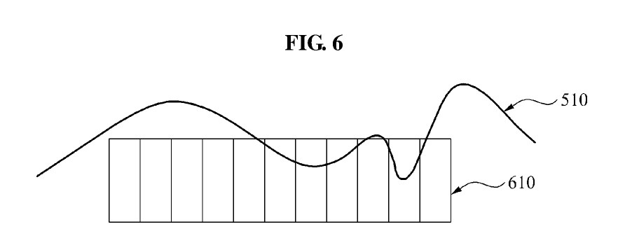

FIG. 6 illustrates a reception power with respect to a ranging up-signal according to an embodiment of the present invention.

FIG. 6 illustrates a channel gain 510 and a reception power 610 with respect to a ranging up-signal received by a base station or a relay station. A transmission power 520 of the ranging up-signal may experience channel-distortion while being transmitted and thus, may have a uniform feature unlike the reception power 610 of FIG. 5. Therefore, the base station or the relay station may quickly detect the received ranging up-signal and thus, the overall data transmission speed may be improved. According to an embodiment, a performance of detecting the ranging up-signal may be improved.

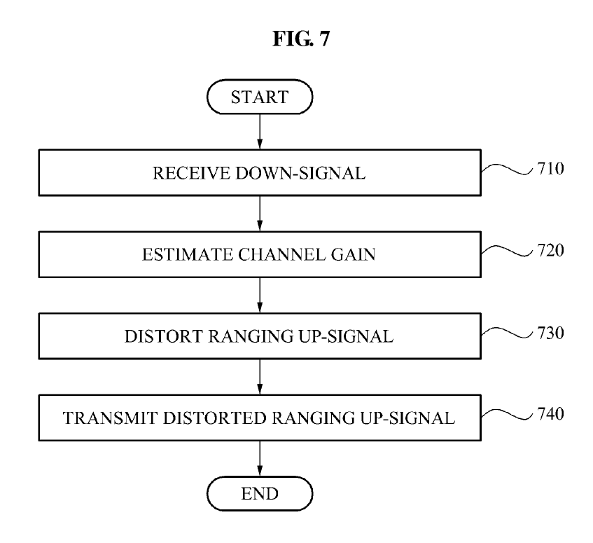

FIG. 7 illustrates a ranging up-signal pre-distortion method according to an embodiment of the present invention.

The ranging up-signal pre-distortion method according to an embodiment of the present invention may be embodied by the ranging up-signal pre-distortion system 300 of FIG. 3. Hereinafter, the ranging up-signal pre-distortion method of FIG. 7 will be described with reference to FIG. 3.

In operation 710, the ranging up-signal pre-distortion system 300 receives a down-signal from an upper node that is a base station or a relay station via a channel.

In operation 720, the ranging up-signal pre-distortion system 300 may estimate a channel gain associated with the channel based on the received down-signal.

The channel gain estimator 320 may compare a transmission power and a reception power with respect to the down-signal to estimate the channel gain. For example, when a transmission power with respect to the down-signal before experiencing the channel-distortion is determined as 100 and a reception power with respect to the down-signal after experiencing the channel-distortion is determined as 90, the channel gain estimator 320 may estimate the channel gain associated with the channel as 0.9.

In operation 730, the ranging up-signal pre-distortion system 300 may distort the ranging up-signal based on the estimated channel gain.

When the ranging up-signal including a plurality of sub-carriers is generated, the signal distortion unit 330 may distort a signal power with respect to each sub-carrier based on the estimated channel gain.

For example, when a ranging up-signal used for synchronizing a frequency and a time where an up-signal arrives at the upper node is generated, the signal distortion unit 330 may distort the ranging up-signal based on the estimated channel gain.

When a ranging up-signal used for requesting, from the upper node, allocation of a frequency is generated, the signal distortion unit 330 may distort the ranging up-signal based on the estimated channel gain.

In operation 740, the ranging up-signal pre-distortion system 300 transmits, to the upper node, the distorted ranging up-signal.

According to an embodiment, the ranging up-signal pre-distortion system 300 may estimate a channel gain on a down-signal transmitted from an upper node that is a base station or a relay station, and may transmit the ranging signal after compensating for, based on the estimated channel gain, a channel distortion to be experienced when ranging signal is transmitted. Therefore, a performance of detecting the ranging up-signal may be improved in the upper node, such as the base station or the relay station.

The method according to the above-described embodiments of the present invention may be recorded in non-transitory computer readable media including program instructions to implement various operations embodied by a computer. The media may also include, alone or in combination with the program instructions, data files, data structures, and the like. Examples of non-transitory computer readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A ranging up-signal pre-distortion system, the system comprising:
a channel gain estimator to estimate a channel gain based on a down-signal; and
a signal distortion unit to distort a ranging up-signal based on the estimated channel gain.

2. The system of claim 1, wherein the channel gain estimator compares a transmission power and a reception power with respect to the down-signal to estimate the channel gain.

3. The system of claim 1, wherein, when the ranging up-signal including a plurality of sub-carriers is generated, the signal distortion unit distorts, based on the estimated channel gain, a signal power with respect to each of the plurality of sub-carriers.

4. The system of claim 1, further comprising:
a signal receiving unit to receive, as the down-signal, a signal transmitted from an upper node that is a base station or a relay station; and
a signal transmitting unit to transmit the distorted ranging up-signal to the upper node.

5. The system of claim 4, wherein the signal transmitting unit transmits, to the upper node, the ranging up-signal that is included in the up-signal and is distorted.

6. The system of claim 1, wherein the signal distortion unit distorts, based on the estimated channel gain, a ranging up-signal used for synchronizing a frequency and a time where an up-signal arrives at the upper node or distorts, based on the estimated channel gain, a ranging up-signal used for requesting, from the upper node, allocation of a frequency.

7. The system of claim 1, further comprising:
a signal receiving unit to receive a signal transmitted from a lower node that is a terminal or a relay station; and
a channel compensation unit to compensate for the received signal based on the estimated channel gain.

8. A ranging up-signal pre-distortion method, the method comprising:
receiving a down-signal transmitted from an upper node that is a base station or a relay station;
estimating a channel gain based on the received down-signal;
distorting a ranging up-signal based on the estimated channel gain; and
transmitting the distorted ranging up-signal to the upper node.

9. The method of claim 8, wherein the estimating comprises:
comparing a transmission power and a reception power with respect to the down-signal to estimate the channel gain.

10. The method of claim 8, wherein the distorting comprises:
when the ranging up-signal including a plurality of sub-carriers is generated, distorting, based on the estimated channel gain, a signal power with respect to each of the plurality of sub-carriers.

11. The method of claim 8, wherein the distorting comprises:
distorting, based on the estimated channel gain, the ranging up-signal used for synchronizing a frequency and a time where the ranging up-signal arrives at the upper node.

12. The method of claim 8, wherein the distorting comprises:
distorting, based on the estimated channel gain, the ranging up-signal used for requesting, from the upper node, allocation of a frequency.

13. The method of claim 8, further comprising:
receiving a signal transmitted from a lower node that is a terminal or a relay station; and
compensating for the received signal based on the estimated channel gain.
